(19) United States
(12) Patent Application Publication
(10) Pub. No.: US 2012/0030238 A1
(43) Pub. Date: Feb. 2, 2012

(54) AUTOMATICALLY IDENTIFYING PERSONALIZED SUPPORT

(75) Inventors: Lisa Seacat DeLuca, San Francisco, CA (US); Brian D. Goodman, Brooklyn, NY (US); Soobaek Jang, Hamden, CT (US)

(73) Assignee: INTERNATIONAL BUSINESS MACHINES CORPORATION, Armonk, NY (US)

(21) Appl. No.: 12/844,132

(22) Filed: Jul. 27, 2010

(51) Int. Cl. G06F 17/30

(52) U.S. Cl. 707/777; 707/E17.099

(57) ABSTRACT

Embodiments of the present invention leverage information of the end-user and personal annotations/tags attached to resources and/or support related thereto (e.g., people, documents, etc.) to provide personalized support. Among other things, these embodiments allow for the mapping of expert “system”-based support to social technology to enable dynamic, localized support. In a typical embodiment, the system will analyze a profile of a user, as well as tags the user has attached to requested computer resources. Based on the profile and the tags, individualized support can be provided automatically.

### TECHNICAL FIELD

The present invention relates to automatically identifying personalized computer resource support. Specifically, the present invention relates to automatically identifying personalized support for computer resources such as cloud computing resources.

### BACKGROUND

The cloud computing environment is an enhancement to the predecessor grid environment, whereby multiple grids and other computation resources may be further abstracted by a cloud layer, thus making disparate devices appear to an end-user as a single pool of seamless resources. These resources may include such things as physical or logical compute engines, servers and devices, device memory, storage devices.

Users in a cloud computing environment have very limited avenues to get support. For example, there could be documents that a provider offers as part of a purchase of resources, as well as pay-per-support type arrangements. Alternatively, web-based forums are an approach to providing informal community-based support. None of these approaches takes into account characteristics of individual users. Rather, previous approaches provide a generic approach for computer resource support.

### SUMMARY

Embodiments of the present invention leverage information of an end-user and personal annotations/tags attached to resources and/or support related thereto (e.g., people, documents, etc.) to provide personalized support. Among other things, these embodiments allow for the mapping of expert “system”-based support to social technology to enable dynamic, localized support. In a typical embodiment, the system will analyze a profile of a user, as well as tags the user has attached to requested computer resources. Based on the profile and the tags, individualized support can be provided automatically.

A first aspect of the present invention provides a method for identifying personalized support for computer resources, comprising: analyzing a profile associated with a user; receiving a request from the user to access a set of computer resources; associating tags provided by the user with the set of computer resources, the tags being used to annotate the set of computer resources; and identifying support resources for the set of computer resources based upon the tags.

A second aspect of the present invention provides a system for identifying personalized support for computer resources, comprising: a bus; a processor coupled to the bus; and a memory medium coupled to the bus, the memory medium comprising instructions to: analyze a profile associated with a user; receive a request from the user to access a set of computer resources; associate tags provided by the user with the set of computer resources, the tags being used to annotate the set of computer resources; and identify support resources for the set of computer resources based upon the tags.

A third aspect of the present invention provides a computer program product for identifying personalized support for computer resources, the computer program product comprising a computer readable storage media, and program instructions stored on the computer readable storage media, to: analyze a profile associated with a user; receive a request from the user to access a set of computer resources; associate tags provided by the user with the set of computer resources, the tags being used to annotate the set of computer resources; and identify support resources for the set of computer resources based upon the tags.

A fourth aspect of the present invention provides a method for deploying a system for identifying personalized support for computer resources, comprising: providing a computer infrastructure being operable to: analyze a profile associated with a user; receive a request from the user to access a set of computer resources; associate tags provided by the user with the set of computer resources, the tags being used to annotate the set of computer resources; and identify support resources for the set of computer resources based upon the tags.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a process flow diagram according to an embodiment of the present invention.

FIG. 5 shows an illustrative interface according to an embodiment of the present invention.

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Embodiments of the present invention leverage information of the end-user and personal annotations/tags attached to resources and/or support related thereto (e.g., people, documents, etc.) to provide personalized support. Among other things, these embodiments allow for the mapping of expert “system”-based support to social technology to enable dynamic, localized support. In a typical embodiment, the system will analyze a profile of a user, as well as tags the user has attached to requested computer resources. Based on the profile and the tags, individualized support can be provided automatically. It is understood that as used herein, the term “computer resource” means any type of computer-based or information technology resource.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

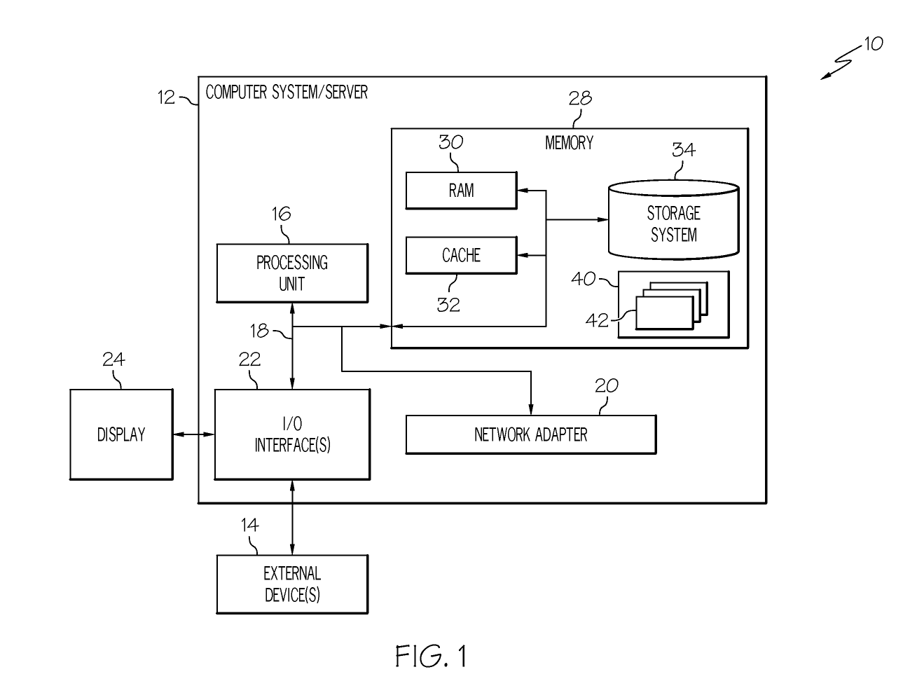

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

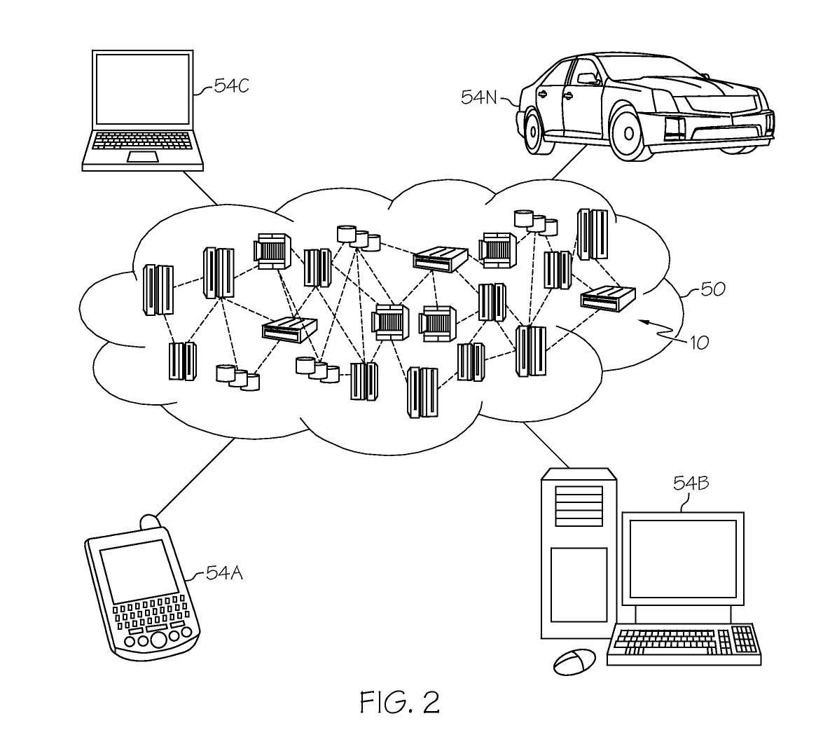

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

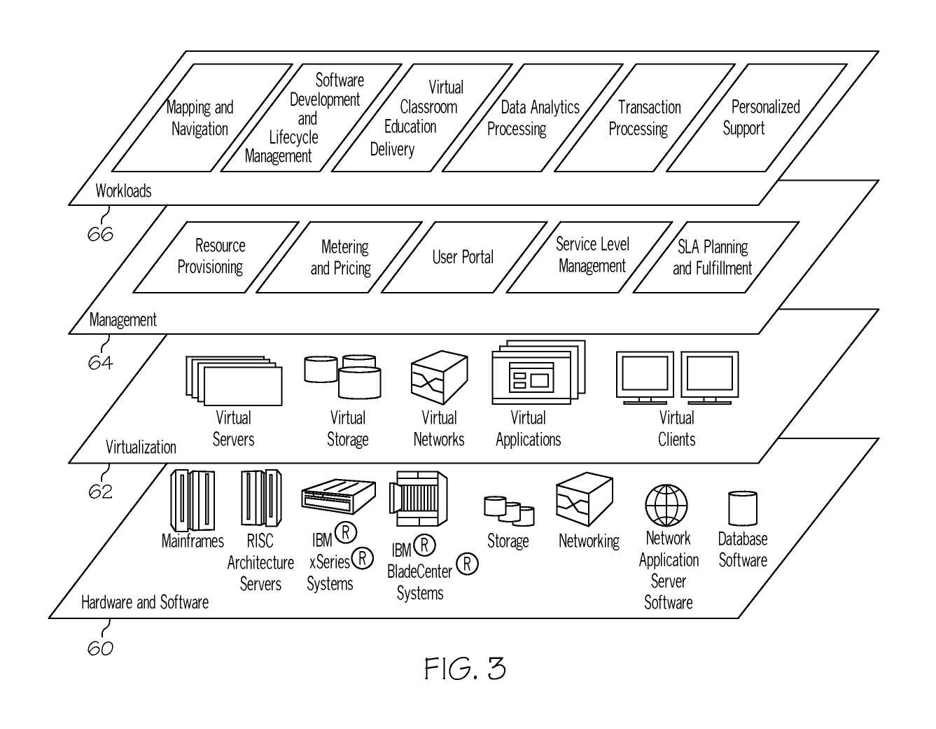

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and personalized support. As mentioned above, all of the foregoing examples described with respect to FIG. 3 are illustrative only, and the invention is not limited to these examples.

It is understood all functions of the present invention as described herein are typically performed by the personalized support function, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description of cloud computing, implementation of the teachings recited herein are not limited to a cloud computing environment. Rather, the embodiments of the present invention are intended to be implemented with any type of clustered computing environment now known or later developed.

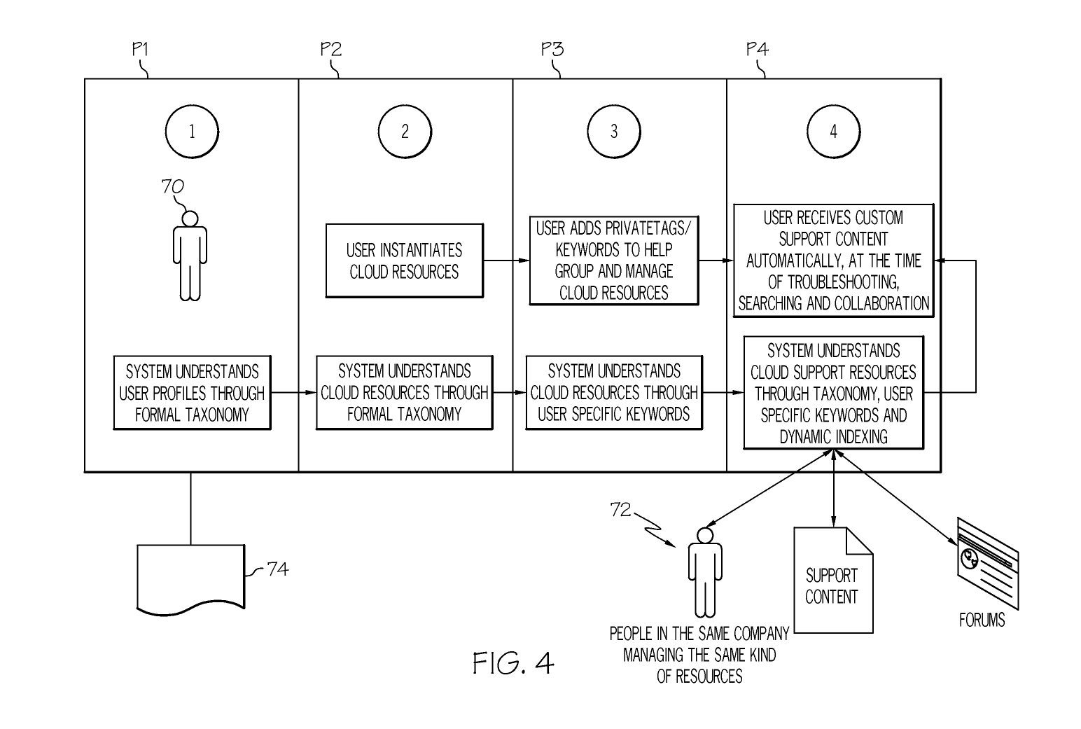

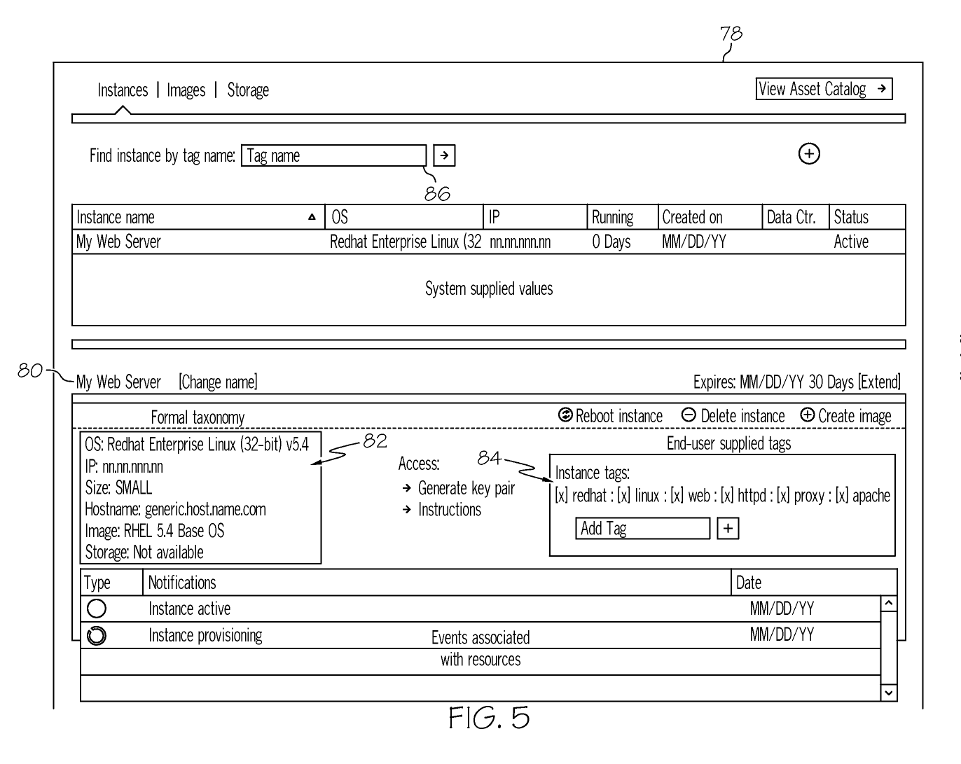

In any event, referring now to FIG. 4, a process flow diagram for identifying personalized support according to an embodiment of the present invention is shown. In step P1, the system analyzes a profile 74 for a user 70 utilizing a set of formal taxonomy entries supplied by a standard source (e.g., based on profiles of other users). This data allows the system to begin to create groupings based on organization, position within an organization, geographic location, demographics, interests, etc. Profile 74 can be any type of profile associated that can be associated with an individual or group such as user 70. For example, profile 74 could be an employee profile, a social networking profile such as Linked-in, FaceBook, etc. FaceBook and related terms are trademarks of Facebook, Inc. in the United States and/or other countries. LinkedIn and related terms are trademarks of LinkedIn Corporation in the United States and/or other countries. In any event, profile 74 can include any type of information that may appear in such situations. In step P2, assume that the user takes an action. In this case, the action can be instantiating/requesting computer resources (e.g., the user has requested instantiation of a virtual machine). Through formal taxonomy attached (e.g., key words such as “virtual” and “machine”) to the requested computer resource, the system is informed about the kind of resources in which this user is interested. Alternatively, this can be enhanced with private metadata added by other users in the operating environment. This embodiment allows the system to create additional groupings (i.e., users that manage similar resources). In step P3, the user adds private tags to specific resources (as shown in FIG. 5) annotating the asset. This action is to enable the user to navigate and manage resources more effectively, not necessarily to share with others, etc. The system understands these cloud resources work through the formal taxonomy, the system provided metadata, and the end-user applied tags. These keywords enhance understanding of the assets under management for the user and for the entire community. Moreover, the tags applied whereby the user helps identify the asset and any group to which the asset may pertain (e.g., a particular project, etc.).

An example of this type of tagging is shown in FIG. 5. As depicted, an interface 78 or the like can be provided under an embodiment of the present invention. Interface 78 allows computer resources to be tagged with not only user-based tags 84, but also system-based tags drawn from a formal taxonomy 82. As shown, the computer resource 80 discussed in FIG. 5 is a web server. It has been specifically tagged with system-based tags by operating system (OS), internet protocol (IP), size, hostname, image, and storage. It has further been tagged by user 70 with tags 84 (e.g., Red Hat, Linux, web, http, proxy, and Apache). As further shown, interface 78 provides a field 86 to search for resources based upon one or more key words. Linux is a trademark of Linus Torvalds in the United States, other countries, or both. Red Hat is a trademark of Red hat, Inc. in the United States, other countries, or both. Apache is a trademark of the Apache group in the United States, other countries, or both.

Regardless, referring back to FIG. 4, the system will receive, analyze, and comprehend the tags applied by user 70. This allows the computer resources to be categorized and/or comprehended according to both user-based tags as well as system-based tags (as well as tags applied by other users).

In step P4, user 70 seeks out support in a variety of ways, including context sensitive help (specific error event occurs), searching topics that are support related, collaborating with other people online, and contacting a support representative. In any of these situations, the system is able to offer targeted support through its knowledge of user 70 (as determined from his/her profile), what they manage, how they think of what they manage, the way others manage similar resources, how others think of their resources, the content supplied formally in the system, the informal end-user generated content, and the dynamic communities they become members of by having a profile and acting in the environment. Support resources 72 can be personnel, content, forums, etc. Regardless, under an embodiment of the present invention, personalized support 72 is automatically identified based upon: previous support resources accessed by user 70; information contained in user 70's profile; and/or tags applied/annotated by user 70, other users, or the system.

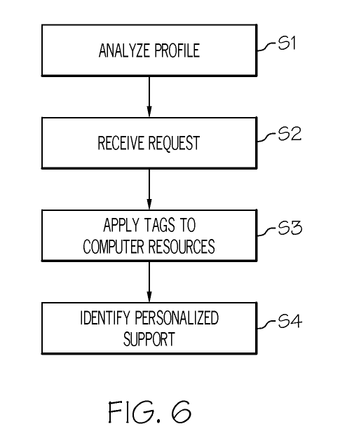

Referring now to FIG. 6, these steps are shown in a flow diagram depicted in FIG. 6. In step S1, a profile associated with a user is analyzed (e.g., based upon a taxonomy associated with a set of profiles of other users). In step S2, a request from the user to access a set of computer resources is received. In step S3, tags provided by the user are associated with the set of computer resources, the tags being used to annotate the set of computer resources. In step S4, support resources are identified for the set of computer resources based upon the tags. As mentioned above, the support resources can comprise personnel, content, and/or forums.

While shown and described herein as a personalized support solution, it is understood that the invention further provides various alternative embodiments. For example, in one embodiment, the invention provides a computer-readable/useable medium that includes computer program code to enable a computer infrastructure to provide personalized support functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide personalized support functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for personalized support. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for identifying personalized support for computer resources, comprising:
analyzing a profile associated with a user;
receiving a request from the user to access a set of computer resources;
associating tags provided by the user with the set of computer resources, the tags being used to annotate the set of computer resources; and
identifying support resources for the set of computer resources based upon the tags.

2. The method of claim 1, the set of computer resources comprising a set of cloud computing resources.

3. The method of claim 1, the support resources comprising at least one of the following: personnel, content, or forums.

4. The method of claim 1, the profile being analyzed based upon a taxonomy associated with a set of profiles of other users.

5. The method of claim 1, the identifying being further based upon previous support resources accessed by the user.

6. The method of claim 1, the identifying being further based upon information contained in the user profile as determined based upon the analyzing.

7. The method of claim 1, the profile comprising an identity of the user, an organization to which the user belongs, a position of the user within the organization, and the identifying being further based upon the profile.

8. The method of claim 1, the tags being used to identify and group the set of computer resources, the set of computer resources having a formal semantic taxonomy associated therewith and additional tags annotated by other users.

9. A system for identifying personalized support for computer resources, comprising:
a bus;
a processor coupled to the bus; and
a memory medium coupled to the bus, the memory medium comprising instructions to:
analyze a profile associated with a user;
receive a request from the user to access a set of computer resources;
associate tags provided by the user with the set of computer resources, the tags being used to annotate the set of computer resources; and
identify support resources for the set of computer resources based upon the tags.

10. The system of claim 9, the set of computer resources comprising a set of cloud computing resources.

11. The system of claim 9, the support resources comprising at least one of the following: personnel, content, or forums.

12. The system of claim 9, the profile being analyzed based upon a taxonomy associated with a set of profiles of other users.

13. The system of claim 9, the support resources being further identified based upon previous support resources accessed by the user.

14. The system of claim 9, the support resources being further based upon information contained in the user profile as determined based upon the analyzing.

15. The system of claim 9, the profile comprising an identity of the user, an organization to which the user belongs, a position of the user within the organization, and the support resources being further identified based upon the profile.

16. The system of claim 9, the tags being used to identify and group the set of computer resources, the set of computer resources having a formal semantic taxonomy associated therewith and additional tags annotated by other users.

17. A computer program product for identifying personalized support for computer resources, the computer program product comprising a computer readable storage media and program instructions stored on the computer readable storage media, to:
analyze a profile associated with a user;
receive a request from the user to access a set of computer resources;
associate tags provided by the user with the set of computer resources, the tags being used to annotate the set of computer resources; and
identify support resources for the set of computer resources based upon the tags.

18. The computer program product of claim 17, the set of computer resources comprising a set of cloud computing resources.

19. The computer program product of claim 17, the support resources comprising at least one of the following: personnel, content, or forums.

20. The computer program product of claim 17, the profile being analyzed based upon a taxonomy associated with a set of profiles of other users.

21. The computer program product of claim 17, further comprising program instructions stored on the computer readable storage media to further identify the support resources based upon previous support resources accessed by the user.

22. The computer program product of claim 17, further comprising program instructions stored on the computer readable storage media to further identify the support resources based upon information contained in the user profile as determined based upon the analyzing.

23. The computer program product of claim 17, the profile comprising an identity of the user, an organization to which the user belongs, a position of the user within the organization, and the computer program product further comprising program instructions stored on the computer readable storage media to further identify the support resources based upon the profile.

24. The computer program product of claim 17, the tags being used to identify and group the set of computer resources, the set of computer resources having a formal semantic taxonomy associated therewith and additional tags annotated by other users.

25. A method for deploying a system for identifying personalized support for computer resources, comprising:
providing a computer infrastructure being operable to:
analyze a profile associated with a user;
receive a request from the user to access a set of computer resources;
associate tags provided by the user with the set of computer resources, the tags being used to identify and group the set of computer resources; and
identify support resources for the set of computer resources based upon the tags.
